(19) United States
(12) Patent Application Publication
(10) Pub. No.: US 2007/0021554 A1
(43) Pub. Date: Jan. 25, 2007

(54) Waterborne UV-crosslinkable thiol-ene polyurethane dispersions

(76) Inventors: Marek W. Urban, Hattiesburg, MS (US); Daniel Otts, Jacksonville, FL (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 11/479,188

(22) Filed: Jun. 30, 2006

Related U.S. Application Data
(60) Provisional application No. 60/696,552, filed on Jul. 1, 2005.

(51) Int. Cl. C08G 18/08

(52) U.S. Cl. 524/591

(57) ABSTRACT

A method for a waterborne photopolymerizable thiol-ene polyurethane dispersion including water, low molecular weight polyurethane prepolymer with terminal unsaturation and pendant acid groups, and a polyfunctional thiol. The dispersion can also include a neutralizing agent. After application of the dispersion to a surface, the water is evaporated and visible light or UV radiation is applied to form a crosslinked network film.

### CROSS REFERENCE TO RELATED APPLICATIONS

This application claims the benefit of provisional application Ser. No. 60/696,552 filed Jul. 1, 2005, the entire contents of which are incorporated by reference herein.

### STATEMENT OF FEDERALLY SPONSORED RESEARCH

The U.S. Government has a paid-up license in this invention and the right in limited circumstances to require the patent owner to license others on reasonable terms as provided by the terms of National Science Foundation Award Number DMR 0213883.

### BACKGROUND OF THE INVENTION

1. Field of Invention

The present invention is directed to polyurethane films. More particularly, the present invention is directed to a waterborne photopolymerizable thiol-ene polyurethane dispersion.

2. Description of the Related Art

Thiol-ene polymers are commercially important for use in engineered systems such as nanotechnology, polymer dispersed liquid crystal systems, and other engineered resin applications. Solvents used for these polymers may pose environmental problems for the polymer manufacturer and often the residual solvent in the final product has an undesirable odor. Environmentally-compliant crosslinkable polymer networks are needed. For example, existing 2-component polyurethanes are made using toxic isocynates crosslinked with polyols. Also, improved gas permeability performance is needed. For example, current UV crosslinkable urethane-acrylate based systems do not effectively control oxygen inhibition. Waterborne crosslinkable polyurethanes are desirable for solving these problems. The present invention seeks to eliminate the issues associated with the toxicity of isocynates and limits oxygen inhibition.

### SUMMARY OF THE INVENTION

The present invention provides a composition for a waterborne UV-crosslinkable thiol-ene polyurethane dispersion including water, low molecular weight polyurethane prepolymer with terminal or pendant unsaturation and terminal or pendant acid groups, and a polyfunctional thiol. The present invention provides a method of forming a thiol-ene polyurethane film including applying an aqueous dispersion containing a polyurethane prepolymer with terminal or pendant unsaturation and terminal or pendant acid groups and a polyfunctional thiol, evaporating the water from the dispersion, and applying visible light or UV radiation to cure the polymer film. Additionally, the present invention provides a polyurethane prepolymer with terminal or pendant unsaturation and terminal or pendant acid groups for forming a waterborne photopolymerizable thiol-ene polyurethane dispersion.

### DETAILED DESCRIPTION

The present invention is directed to waterborne photopolymerizable thiol-ene polyurethane dispersions and films thereof. In a preferred embodiment, the photopolymerizable thiol-ene polyurethane dispersions are formed by the synthesis of low molecular weight polyurethane prepolymer which, upon combination with a polyfunctional thiol, is dispersed in water to form a uniform, one component colloidal dispersion with latent crosslinking ability. The polyfunctional thiol is emulsified by the water-dispersible polyurethane prepolymer because of the water insolubility of the polyfunctional thiol.

The low molecular weight polyurethane prepolymer bearing unsaturated end groups and the polyfunctional thiol are combined in stoichiometric amounts ranging from 0.5-1.5 mol/mol ratio in the presence of an appropriate neutralizing agent to form a clear, colloidal, viscous liquid dispersion. The stoichiometric amount is selected based on the desired SH/C═C molar ratio. As the ratio increases, the resulting dispersion glass transition temperature decreases and the storage modulus increases, indicating an increase of the cross-linking within the dispersion. When the colloidal dispersion is applied to a substrate and water evaporates, photopolymerization results in a film with a crosslinked network. The stoichiometric amount of polyurethane prepolymer and polyfunctional thiol is adjusted to produce dispersions with varying levels of reactive groups based on the acid content of the polyurethane prepolymer.

The following chemical formula outlines an embodiment of the chemical reactions leading to the synthesis of the dispersion. A polyurethane prepolymer is formed by combining difunctional alcohols, difunctional acids, difunctional isocyanates, and monofunctional hydroxyl compounds having one or more photopolymerizable unsaturated carbon double bonds. Examples of difunctional alcohols include ethylene glycol, 1,2- and 1,3-propylene glycol, 1,3- and 1,4-butanediol, 1,6-hexanediol, 1,8-octanediol, neopentyl glycol, diethylene glycol, 2-methyl-1,3-propylene glycol, 2,2-dimethyl-1,3-propylene glycol, the various isomeric bis-hydroxymethyl cyclohexanes, 2,2,4-trimethyl-1,3-pentanediol, as well as poly(ethylene glycol), poly(propylene glycol), and random and/or block copolymers of ethylene glycol and propylene glycol.

Examples of difunctional acids include succinic acid, adipic acid, suberic acid, azelaic acid, sebacic acid, phthalic acid, isophthalic acid, trimellitic acid, phthalic acid anhydride, tetrahydropthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, and dimeric and trimeric fatty acids such as oleic acid.

Examples of difunctional isocyanates include ethylene diisocyanate, 1,4-tetramethylene diisocyanate, 1,6-hexamethylene diisocyanate, 2,4,4-trimethyl-1,6-hexamethylene diisocyanate, 1,12-dodecane diisocyanate, cyclobutane-1,3-diisocyanate, cyclohexane-1,3- and/or -1,4-diisocyanate, 1-isocyanato-2-isocyanatomethyl cyclopentane, 1-isocyanato-3,3,5-trimethyl-5-isocyanatomethyl cyclohexane (isophorone diisocyanate or IPDI), 2,4- and/or 2,6-hexahydrotoluylene diisocyanate, 2,4′- and/or 4,4′-dicyclohexylmethane diisocyanate, .alpha.,.alpha.,.alpha.′,.alpha.′-tetramethyl-1,3- and/or -1,4-xylylene diisocyanate, 1,3- and 1,4-xylylene diisocyanate, 1-isocyanato-1-methyl-4(3)-isocyanatomethylcyclohexane, 1,3- and 1,4-phenylene diisocyanate, 2,4- and/or 2,6-toluylene diisocyanate, diphenyl methane-2,4′- and/or -4,4′-diisocyanate, naphthalene-1,5-diisocyanate, and condensates and/or mixtures of the above-mentioned polyisocyanates.

Examples of mono-hydroxy compounds having one or more photopolymerizable C═C bonds include pentaerythritol triallyl ether and derivatives thereof, pentaerythritol triacrylate and derivatives thereof, pentaerythritol trimethacrylate and derivatives thereof.

For example, as illustrated, poly(neopentyl glycol adipate), isophorone diisocyanate, dimethylol propionic acid, and pentaerythritol allyl ether are combined and mildly agitated for about 8 hours. This prepolymer is then neutralized and mixed with pentaerythritol tetrakis(3-mercaptopropionate) to form a UV curable dispersion.

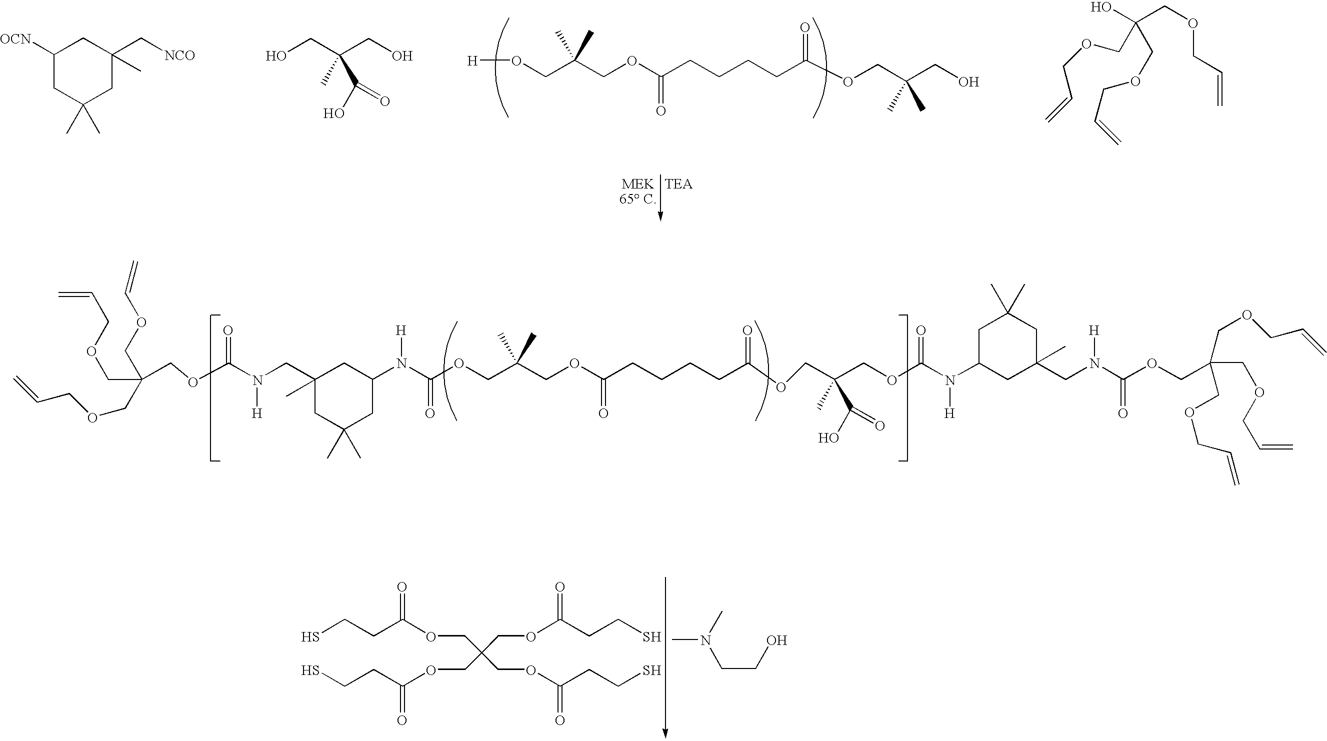

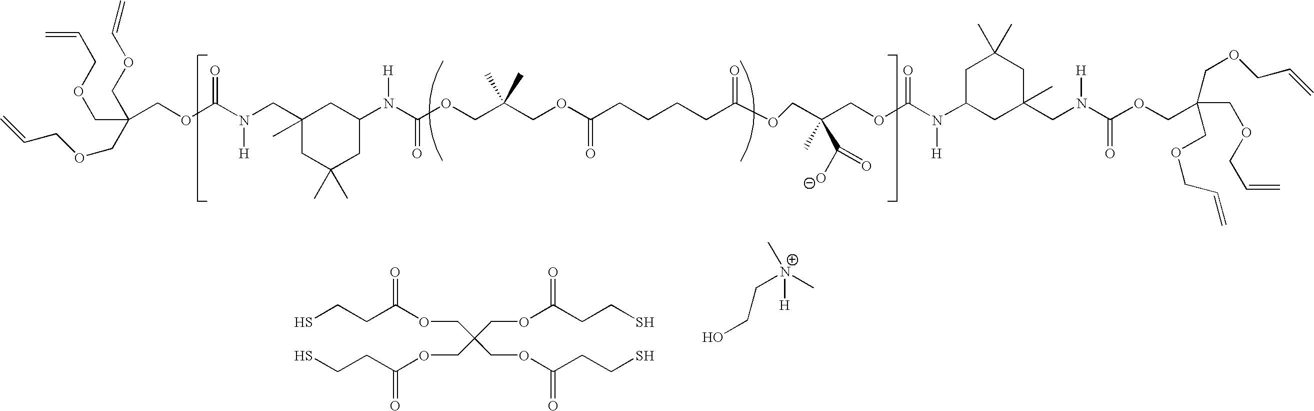

The polyurethane prepolymer is a polyurethane with terminal and/or pendant unsaturation and terminal and/or pendant acid groups. Polyurethane with terminal unsaturation and pendant acid groups includes polyurethane with ene functionality, that is a polyurethane with the ability to have a carbon carbon double bond upon processing. The polyurethane prepolymer may have a number average molecular weight of about 500 g/mol to about 20,000 g/mol such as about 2,450 g/mol as determined by gel permeation chromatography. Other compounds that can be used to create the thiol-ene polyurethane dispersion include any OH-terminated prepolymers, such as polyesters, polyacrylates, polyethylene glycols, and any OH-functional species that is water dispersible.

The polyurethane prepolymer is combined with a polyfunctional thiol such as pentaerythritol tetrakis(3-mercaptopropionate) (PET3 MP) and neutralizing agent to form the dispersion. Any poly-functional water-dispersible thiol activated by visible light or UV radiation would perform effectively. Additional polyfunctional thiols that can be used in the present invention include trifunctional or tetrafunctional thiols. Thiol esters and thiol acrylates can be used. The polyfunctional thiol may have a number average molecular weight of about 100 g/mol to about 20,000 g/mol such as 488.66 g/mol as determined by gel permeation chromatography.

The neutralizing agent may be any neutralizing agent including a base capable of neutralizing acid groups, such as an amine compound and/or a volatile neutralizing agent. Examples include ammonia, trimethylamine, triethylamine, triisopropylamine, tributylamine, N,N-dimethyl-cyclohexylamine, N,N-dimethylstearylamine, N,N-dimethylaniline, N-methylmorpholine, N-ethyl-morpholine, N-methylpiperazine, N-methylpyrrolidine, N-methylpiperidine, N,N-dimethylethanolamine, N,N-diethylethanolamine, triethanolamine, N-methyldiethanolamine, dimethyl aminopropanol, 2-methoxy-ethyldimethylamine, N-hydroxyethylpiperazine, 2-(2-dimethylaminoethoxy)ethanol and 5-diethylamino-2-pentanone. N,N-dimethylethanolamine is the preferred neutralizing agent. Water may also be added to the mixture of polyurethane prepolymer, polyfunctional thiol, and neutralizing agent. In some instances, the water is added dropwise.

The thiol-ene polyurethane dispersion is applied to a surface and the water is allowed to evaporate to form a film. Various processes can be employed to encourage evaporation. After the water has evaporated, visible light or UV radiation is applied to crosslink the polymer. The visible light or UV radiation may have a wavelength of about 200 to about 800 nm, more precisely, about 200 to about 400 nm. In a preferred embodiment, UV radiation with a wavelength of 254 nm is applied. The time for exposure to visible light or UV radiation varies based on the thickness of the film from about 1 second to about 20 minutes. In some instances, the time for exposure may be about 1 second to about 5 hours. All of the processing steps including forming the polyurethane prepolymer, forming the dispersion, and forming the film may be performed at room temperature to an elevated temperature, about 20° C. to about 120° C. The resulting film thickness is about 1 μm to about 500 μm, preferably about 25 μm to about 130 μm.

The thiol-ene polyurethane dispersion has an average particle size that is related to the SH/C═C molar ratio. For example, thiol-ene polyurethane dispersions with particle sizes of about 50 nm to about 130 nm are obtained for SH/C═C molar ratios of about 0.50 to about 1.50, respectively, corresponding to about 16 to about 30 weight percent PET3 MP, based on solid contents. The solids content of dispersions is about 20 weight percent based on the total mass of prepolymer and PET3 MP.

The invention can be further understood by the following examples.

### EXAMPLE 1

A polyurethane prepolymer was prepared as described by the chemical formula illustrated above. The amounts of the reagents used are denoted in Table 1. Poly(neopentyl glycol adipate) (PNGA, hydroxy end-capped, Mₙ=600 g*mol⁻¹), isophorone diisocyanate (IPDI, 98%, mixture of isomers), dimethylol propionic acid (DMPA, 97%), pentaerythritol allyl ether (PEAE, tech, 70%), N,N-dimethylethanolamine (DMEA, 99.5%), pentaerythritol tetrakis(3-mercaptopropionate) (PET3 MP, 97.4%), and triethylamine (TEA, 99.8%) were purchased from Aldrich Chemical Company. Methyl ethyl ketone (MEK, 99.8%) was purchased from Fisher Scientific, Inc. All reagents were used as received. Polyurethane prepolymers with M_{w}=2450 g/mol (GPC) were prepared by reacting pNGA, IPDI, PEAE, and DMPA at 65° C. for 8 hours in MEK using TEA catalysis (0.5 wt % of total mass) and mild agitation. After 8 hours, the reaction was completed as evidenced by the disappearance of the NCO band at 2265 cm⁻¹. The disappearance of the NCO band at 2265 cm⁻¹ indicates that crosslinking reaction and film formation occurred. The reaction mixture was then cooled to ambient temperature, yielding a clear, viscous liquid.

Thiol-ene polyurethane dispersions of the polyurethane prepolymers and PET3 MP were prepared by dissolving PET3 MP and a stoichiometric amount of DMEA (based on acid content of polyurethane prepolymer) in MEK/polyurethane prepolymer solutions followed by the dropwise addition of water at 25° C. Additionally, the thiol/ene (SH/C═C) stoichiometric ratio was adjusted to produce dispersions with varying levels of reactive groups. The MEK was subsequently removed by rotary evaporation at 60° C., producing non-viscous TE-PUD having an average particle size of 56, 80, 110, and 126 nm for SH/C═C molar ratios of 0.50, 0.75, 1.00, and 1.10, respectively, which corresponds to 16.4, 22.8, 28.2, and 30.2 weight percent PET3 MP, based on solids. Solids contents of dispersions were approximately 20 weight percent (based on total mass of prepolymer and PET3 MP). The photocurable TE-PUD was applied to glass substrates and allowed to dry at 30° C. for 30 minutes to obtain films of approximately 25 μm dried thickness. Additional films were prepared by casting TE-PUD's in polytetrafluoroethylene molds followed by drying at 30° C. for 2 hours. All films were then photopolymerized by exposure to 254 nm UV radiation for 20 minutes to form defect-free, clear, and mechanically stable solid films. Film thickness values of the specimens ranged from approximately 90 to 130 μm. Shear mode dynamic mechanical analysis (DMA) measurements of these films were performed using a TA Instruments DMA Q800 at 1 Hz with a 5 μm amplitude over the temperature range of −50 to 120° C. at 3° C.*min⁻¹. Differential scanning calorimetry (DSC) was performed on dried, un-photopolymerized polyurethane prepolymer using a TA Instruments DSC Q100 with a heating rate of 10° C.*min⁻¹.

Gel permeation chromatography was performed using a Waters Alliance system (model 2695) equipped with a refractive index detector using a PLGel column (Polymer Laboratories, Inc.) calibrated with narrow polydispersity polystyrene standards. Attenuated total reflectance Fourier transform infrared (ATR-FTIR) spectroscopic measurements were performed using a Digilab FTS-6000 spectrometer equipped with a fixed Ge single internal reflection element having an angle of incidence of 45° (Pike Technologies, Inc.) and a DTGS detector. A total of 200 scans were coadded and ratioed 200 background scans. When necessary, multi-point, linear baseline correction algorithms were applied to correct for baseline deviations. ¹H-NMR measurements were made on a Varian 300 MHz spectrometer using 8 scans, a pulse width of 3.55 μs, and relaxation delays of 1 second for monomers and 5 seconds for polymers. Samples for NMR analysis were dissolved in DMSO-d₆. Particle size distributions of TE-PUD were performed on a Microtrac Nanotrac 250 particle size analyzer.

TABLE 1
Reagents and charges used in the synthesis
of a polyurethane prepolymer.

| | Molar mass | mol | | wt. |
|---|---|---|---|---|
| Component | (g/mol) | ratio | mmol | fraction |
| poly(neopentyl glycol | 600.00 | 2.70 | 19.0 | 0.414 |
| adipate), pNGA | | | | |
| isophorone diisocyanate, | 222.28 | 6.40 | 45.0 | 0.364 |
| IPDI | | | | |
| dimethylol propionic | 134.13 | 2.70 | 19.0 | 0.093 |
| acid, DMPA | | | | |
| pentaerythritol allyl | 242.15 | 2.10 | 14.8 | 0.130 |
| ether, PEAE | | | | |
| methyl ethyl ketone, MEK | 72.11 | n/a | n/a | n/a |
| triethylamine, TEA | 101.19 | n/a | n/a | 0.005 |
| | | | Total | 1.00 |
| | | | Solids | 27.5% w/w |

### EXAMPLE 2

Dynamic mechanical analysis (DMA) measurements were performed on films photopolymerized for 20 minutes with SH/C═C stoichiometric ratios ranging from 0.50 to 1.10. The measurements indicated that with increasing amounts of PET3 MP (i.e. increased SH/C═C ratio), a decrease in the glass transition temperature, T_{g} is observed. Specifically, glass transition temperatures of 46° C., 43° C., 37° C., and 36° C. were observed for SH/C═C ratios of 0.50, 0.75, 1.00, and 1.10, respectively. Furthermore, the storage modulus (E′) values in the rubbery plateau region of approximately 80-120° C. also increase with the increasing SH/C═C ratio, indicating increased crosslink density.

Dispersion exposure to 254 nm UV radiation also results in significant physical property changes. Specifically, non-crosslinked TE-PUD films exhibit a glass transition temperature of approx −9.0° C. as measured by differential scanning calorimetry, which is attributed to a combination of the low molecular mass of the prepolymer as well as plasticization effects of the polyfunctional thiol dissolved in the film. The results of NMR and IR spectroscopic analysis indicate that the thiol and ene functionalities are preserved and available for further crosslinking reaction in dried non-crosslinked TE-PUD films. However, upon UV exposure in air, the glass transition temperature increases due to the formation of a crosslinked network.

As can be seen from the foregoing, the present invention provides a viable crosslinking mechanism which can be utilized in “one component” polyurethane aqueous dispersions with low to zero volatile organic compound levels. Such TE-PUD systems can be optimized to achieve desirable physical properties which can be adjusted by alterations of the S—H/C═C ratio as well as the polyurethane composition. Defect-free, clear, and mechanically stable solid films can be formed using this process. The step-growth radical addition mechanism of thiol-ene systems facilitates development of a photopolymerizable system having significantly less oxygen inhibition than current photopolymerizable urethane-acrylate based systems. Also, the odor of the resulting films was decreased compared to films made using methods that did not use visible light or UV exposure as part of the polymer synthesis or film manufacturing process.

While the invention has been described with respect to the presently preferred embodiments, it will be appreciated by those skilled in the art that various modifications can be made without departing from the spirit of the invention. It will be obvious to one of ordinary skill in the art that various changes may be made without departing from the scope of the invention, which is not to be considered limited to what is described in the specification.

What is claimed is:

1. A waterborne photopolymerizable thiol-ene polyurethane dispersion comprising:
water;
a polyurethane prepolymer with terminal or pendant unsaturation and terminal or pendant acid groups; and
a polyfunctional thiol.

2. The dispersion of claim 1, wherein the thiol to polyurethane prepolymer ratio is between about 0.5 and 1.5 mol/mol.

3. The dispersion of claim 1, further comprising a neutralizing agent.

4. The dispersion of claim 3, wherein the neutralizing agent is selected from the group consisting of ammonia, trimethylamine, triethylamine, triisopropylamine, tributylamine, N,N-dimethyl-cyclohexylamine, N,N-dimethylstearylamine, N,N-dimethylaniline, N-methylmorpholine, N-ethyl-morpholine, N-methylpiperazine, N-methylpyrrolidine, N-methylpiperidine, N,N-dimethylethanolamine, N,N-diethylethanolamine, triethanolamine, N-methyldiethanolamine, dimethyl aminopropanol, 2-methoxy-ethyldimethylamine, N-hydroxyethylpiperazine, 2-(2-dimethylaminoethoxy)ethanol and 5-diethylamino-2-pentanone.

5. The dispersion of claim 1, wherein the polyurethane prepolymer has a number average molecular weight of about 500 g/mol to about 20,000 g/mol.

6. The dispersion of claim 1, wherein the polyurethane prepolymer comprises the reaction product of difunctional alcohol, difunctional acid, difunctional isocyanate, and monofunctional hydroxyl compound having one or more photopolymerizable unsaturated carbon double bond.

7. The dispersion of claim 6, wherein the difunctional alcohol is selected from the group consisting of ethylene glycol, 1,2- and 1,3-propylene glycol, 1,3- and 1,4-butanediol, 1,6-hexanediol, 1,8-octanediol, neopentyl glycol, diethylene glycol, 2-methyl-1,3-propylene glycol, 2,2-dimethyl-1,3-propylene glycol, isomeric bis-hydroxymethyl cyclohexanes, 2,2,4-trimethyl-1,3-pentanediol, poly(ethylene glycol), poly(propylene glycol), and random and/or block copolymers of ethylene glycol and propylene glycol.

8. The dispersion of claim 6, wherein the difunctional acid is selected from the group consisting of succinic acid, adipic acid, suberic acid, azelaic acid, sebacic acid, phthalic acid, isophthalic acid, trimellitic acid, phthalic acid anhydride, tetrahydropthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, and dimeric and trimeric fatty acids.

9. The dispersion of claim 6, wherein the difunctional isocyanate is selected from the group consisting of ethylene diisocyanate, 1,4-tetramethylene diisocyanate, 1,6-hexamethylene diisocyanate, 2,4,4-trimethyl-1,6-hexamethylene diisocyanate, 1,12-dodecane diisocyanate, cyclobutane-1,3-diisocyanate, cyclohexane-1,3- and/or -1,4-diisocyanate, 1-isocyanato-2-isocyanatomethyl cyclopentane, 1-isocyanato-3,3,5-trimethyl-5-isocyanatomethyl cyclohexane (isophorone diisocyanate or IPDI), 2,4- and/or 2,6-hexahydrotoluylene diisocyanate, 2,4′- and/or 4,4′-dicyclohexylmethane diisocyanate, .alpha.,.alpha.,.alpha.′,.alpha.′-tetramethyl-1,3- and/or -1,4-xylylene diisocyanate, 1,3- and 1,4-xylylene diisocyanate, 1-isocyanato-1-methyl-4(3)-isocyanatomethylcyclohexane, 1,3- and 1,4-phenylene diisocyanate, 2,4- and/or 2,6-toluylene diisocyanate, diphenyl methane-2,4′- and/or -4,4′-diisocyanate, naphthalene-1,5-diisocyanate, and condensates and mixtures thereof.

10. The dispersion of claim 6, wherein the monofunctional hydroxyl compounds is selected from the group consisting of pentaerythritol triallyl ether and derivatives thereof, pentaerythritol triacrylate and derivatives thereof, and pentaerythritol trimethacrylate and derivatives thereof.

11. The dispersion of claim 1, wherein the polyurethane prepolymer comprises the reaction product of poly(neopentyl glycol adipate), isophorone diisocyanate, dimethylol propionic acid, and pentaerythritol allyl ether.

12. The dispersion of claim 1, wherein the polyfunctional thiol is selected from the group consisting of a trifunctional thiol, a tetrafunctional thiol, a thiol ester, and a thiol acrylate.

13. The dispersion of claim 1, wherein the polyfunctional thiol is pentaerythritol tetrakis(3-mercaptopropionate).

14. The dispersion of claim 1, wherein the polyfunctional thiol has a number average molecular weight of about 100 g/mol to about 20,000 g/mol.

15. A polyurethane prepolymer,
wherein the prepolymer has terminal or pendant unsaturation and terminal or pendant acid groups, and
wherein the polyurethane prepolymer comprises the reaction product of difunctional alcohol, difunctional acid, difunctional isocyanate, and monofunctional hydroxyl compounds having one or more photopolymerizable unsaturated carbon double bonds.

16. The dispersion of claim 15, wherein the polyurethane prepolymer has a number average molecular weight of about 500 g/mol to about 20,000 g/mol.

17. The dispersion of claim 15, wherein the difunctional alcohol is selected from the group consisting of ethylene glycol, 1,2- and 1,3-propylene glycol, 1,3- and 1,4-butanediol, 1,6-hexanediol, 1,8-octanediol, neopentyl glycol, diethylene glycol, 2-methyl-1,3-propylene glycol, 2,2-dimethyl-1,3-propylene glycol, isomeric bis-hydroxymethyl cyclohexanes, 2,2,4-trimethyl-1,3-pentanediol, poly(ethylene glycol), poly(propylene glycol), and random and/or block copolymers of ethylene glycol and propylene glycol.

18. The dispersion of claim 15, wherein the difunctional acid is selected from the group consisting of succinic acid, adipic acid, suberic acid, azelaic acid, sebacic acid, phthalic acid, isophthalic acid, trimellitic acid, phthalic acid anhydride, tetrahydropthalic acid anhydride, hexahydrophthalic acid anhydride, tetrachlorophthalic acid anhydride, endomethylene tetrahydrophthalic acid anhydride, glutaric acid anhydride, maleic acid, maleic acid anhydride, fumaric acid, and dimeric and trimeric fatty acids.

19. The dispersion of claim 15, wherein the difunctional isocyanate is selected from the group consisting of ethylene diisocyanate, 1,4-tetramethylene diisocyanate, 1,6-hexamethylene diisocyanate, 2,4,4-trimethyl-1,6-hexamethylene diisocyanate, 1,12-dodecane diisocyanate, cyclobutane-1,3-diisocyanate, cyclohexane-1,3- and/or -1,4-diisocyanate, 1-isocyanato-2-isocyanatomethyl cyclopentane, 1-isocyanato-3,3,5-trimethyl-5-isocyanatomethyl cyclohexane (isophorone diisocyanate or IPDI), 2,4- and/or 2,6-hexahydrotoluylene diisocyanate, 2,4′- and/or 4,4′-dicyclohexylmethane diisocyanate, .alpha.,.alpha.,.alpha.′,.alpha.′-tetramethyl-1,3- and/or -1,4-xylylene diisocyanate, 1,3- and 1,4-xylylene diisocyanate, 1-isocyanato-1-methyl-4(3)-isocyanatomethylcyclohexane, 1,3- and 1,4-phenylene diisocyanate, 2,4- and/or 2,6-toluylene diisocyanate, diphenyl methane-2,4′- and/or -4,4′-diisocyanate, naphthalene-1,5-diisocyanate, and condensates and mixtures thereof.

20. The dispersion of claim 15, wherein the mono-hydroxy compound is selected from the group consisting of pentaerythritol triallyl ether and derivatives thereof, pentaerythritol triacrylate and derivatives thereof, and pentaerythritol trimethacrylate and derivatives thereof.

21. The dispersion of claim 15, wherein the polyurethane prepolymer comprises the reaction product of poly(neopentyl glycol adipate), isophorone diisocyanate, dimethylol propionic acid, and pentaerythritol allyl ether.

22. A method of forming a thiol-ene polyurethane film, comprising:
applying a waterborne photopolymerizable thiol-ene polyurethane dispersion of claim 1 to a substrate;
evaporating water from the dispersion; and
applying visible light or UV radiation to cure the polyurathane.

23. The method of claim 22, wherein the radiation has a wavelength of about 200 nm to about 800 nm.

24. The method of claim 22, wherein the radiation has a wavelength of about 200 nm to about 400 nm.

25. The method of claim 22, wherein the applying the radiation is performed for about 1 second to about 20 minutes.

26. The method of claim 22, wherein the applying the waterborne dispersion, evaporating water, and applying radiation occur at about 20° C. to about 120° C.

27. A crosslinked film formed by the method of claim 22.

28. The film of claim 27, wherein the film has a thickness of about 1 μm to about 500 μm.

29. The film of claim 27, wherein the film has a thickness of about 25 μm to about 130 μm.
